(19) United States
(12) Patent Application Publication
(10) Pub. No.: US 2010/0259848 A1
(43) Pub. Date: Oct. 14, 2010

(54) METHOD AND CIRCUIT FOR HEAD FLYING HEIGHT CONTROL, AND MAGNETIC STORAGE DEVICE

(75) Inventor: Yoshiyuki NANBA, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/824,005

(22) Filed: Jun. 25, 2010

Related U.S. Application Data
(63) Continuation of application No. PCT/JP2008/051767, filed on Feb. 4, 2008.

(51) Int. Cl. G11B 21/02

(52) U.S. Cl. 360/75; G9B/21.003

(57) ABSTRACT

According to one embodiment, there is provided a head flying height control method for controlling a flying height of a magnetic head from a magnetic storage medium. The magnetic head includes an element portion and a heater that effects a change in a protrusion amount of the element portion due to thermal expansion accompanying heat generation. The head flying height control method includes: causing the element portion to protrude a maximum protrusion amount by increasing a heater power of the heater; first-reducing the heater power based on a relation between the protrusion amount and the heater power until the protrusion amount becomes a predetermined protrusion amount; and second-reducing, if a head-medium property is better than a target value after the first-reducing, the heater power based on a relation between the head-medium property and the heater power so that the head-medium property matches the target value.

### CROSS-REFERENCE TO RELATED APPLICATIONS

This application is a continuation of PCT international application Ser. No. PCT/JP2008/051767 filed on Feb. 4, 2008 which designates the United States, incorporated herein by reference.

### FIELD

Embodiments described herein relate generally to a head flying height control method, a head flying height control circuit, and a magnetic storage device.

### BACKGROUND

In recent years, there has been a significant advance in the performance of notebook personal computers. With such advance, there is a demand for increasing the storage capacity of magnetic disks to be installed. Recently, magnetic disks having recording density of 200 Gbit/in² are being put to practical use and it is expected that there would be demand for further enhancement in the recording density. An effective way for enhancing the recording density is to reduce the distance between a magnetic head and a corresponding magnetic disk, i.e., the flying height of the magnetic head from the corresponding magnetic disk. In regard to that point, the flying height in recent magnetic disk devices has been reduced to about 10 nm.

For example, Japanese Patent Application Publication (KOKAI) No. H05-20635 discloses a conventional method for further reducing the flying height and moving a magnetic head closer to a corresponding magnetic disk. According to the conventional method, a heater is disposed in a reader/writer of the magnetic head and protrusion of the magnetic head that occurs due to thermal expansion is used as a means for shortening the distance between the magnetic head and the corresponding magnetic disk.

As an application of the above conventional method, a heater current can be continuously applied until the magnetic head comes in contact with the magnetic disk and then, by controlling the heater current value, a certain flying height can be secured with reference to the contact surface of the magnetic disk with the magnetic head. In this method, variability in the flying height at the time when no heater current is applied gets adjusted. Hence, the flying height may be controlled with accuracy even within the region of 10 nm or less.

Japanese Patent Application Publication (KOKAI) No. 2007-310957 discloses a conventional method for controlling the flying height of a magnetic head from a magnetic disk according to an error rate.

In the application of the conventional method, by keeping the head flying height within the region of 10 nm or less, there is almost no safety margin against head/disk interference (HDI). Hence, if the head flying height further decreases due to some reason, the magnetic head is likely to come in contact with the magnetic disk surface, resulting in a head crash. Meanwhile, individual magnetic heads have different recording/reproducing characteristics. For a magnetic head having a good recording/reproducing characteristic, a good signal characteristic can be obtained without much reducing the flying height, and thereby it is possible to achieve a desired recording density. However, typically, in the case of enhancing the recording/reproducing characteristic by means of protrusion of a magnetic head that occurs due to thermal expansion, no consideration is given to the fact that individual magnetic heads have different recording/reproducing characteristics.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a magnetic storage device according to an embodiment;

FIG. 2 is an exemplary partial cross-sectional view of a magnetic head in the embodiment;

FIG. 3 is an explanatory diagram for explaining the flying height of the magnetic head from a magnetic disk in the embodiment;

FIG. 4 is an exemplary flowchart for explaining the operation in the embodiment;

FIG. 5 is an exemplary graph of a relation between VTM values and heater current stored in a storage module in the embodiment;

FIG. 6 is a graph of the heater current reset using approximation formulae in the embodiment;

FIG. 7 is a graph of a relation between a flying height and a VTM value in each magnetic head upon resetting the heater current value in the embodiment;

FIG. 8 is an exemplary flowchart of the operation of measuring a head/medium property at a plurality of locations on the magnetic disk in the embodiment; and

FIG. 9 is an exemplary flowchart of the operation of measuring a head/medium property under a plurality of temperature environments in the embodiment.

### DETAILED DESCRIPTION

In general, according to one embodiment, there is provided a head flying height control method for controlling a flying height of a magnetic head from a magnetic storage medium. The magnetic head includes an element portion and a heater that effects a change in a protrusion amount of the element portion due to thermal expansion accompanying heat generation. The head flying height control method includes: causing the element portion to protrude a maximum protrusion amount by increasing a heater power of the heater; first-reducing the heater power based on a relation between the protrusion amount and the heater power until the protrusion amount becomes a predetermined protrusion amount; and second-reducing, if a head-medium property is better than a target value after the first-reducing, the heater power based on a relation between the head-medium property and the heater power so that the head-medium property matches the target value.

According to another embodiment, a head flying height control circuit is configured to control a flying height of a magnetic head from a magnetic storage medium. The magnetic head includes an element portion and a heater that effects a change in a protrusion amount of the element portion due to thermal expansion accompanying heat generation. The head flying height control circuit comprises a first module, a second module, and a third module. The first module is configured to cause the element portion to protrude a maximum protrusion amount by increasing a heater power of the heater. The second module is configured to reduce the heater power based on a relation between the protrusion amount and the heater power until the protrusion amount becomes a predetermined protrusion amount. The third module is configured to reduce, if a head-medium property is better than a target value after the second module reduces the heater power, the heater power based on a relation between the head-medium property and the heater power so that the head-medium property matches the target value.

According to still another embodiment, a magnetic storage device comprises a magnetic head and a head flying height control circuit. The magnetic head comprises an element portion and a heater that effects a change in a protrusion amount of the element portion due to thermal expansion accompanying heat generation. The head flying height control circuit is configured to control a flying height of the magnetic head from a magnetic storage medium. The head flying height control circuit comprises a first module, a second module, and a third module. The first module is configured to cause the element portion to protrude a maximum protrusion amount by increasing a heater power of the heater. The second module is configured to reduce the heater power based on a relation between the protrusion amount and the heater power until the protrusion amount becomes a predetermined protrusion amount. The third module is configured to reduce, if a head-medium property is better than a target value after the second module reduces the heater power, the heater power based on a relation between the head-medium property and the heater power so that the head-medium property matches the target value.

According to an embodiment, the flying height of a magnetic head, which comprises an element portion and a heater that effects a change in the protrusion amount of the element portion due to thermal expansion accompanying heat generation, from a magnetic storage medium is controlled by causing the element portion to protrude to the maximum by increasing the heater power of the heater. The heater power is then reduced based on a relation between the protrusion amount and the heater power until the protrusion amount becomes a predetermined amount. If a head/medium property is smaller than a target value, the heater power is reduced based on a relation between the head/medium property and the heater power so that the head/medium property matches the target value.

Hence, by securing the minimum required flying height and by expanding the flying margin according to the recording/reproducing characteristic of each magnetic head, it becomes possible to avoid risks such as a head crash that occur due to low flying height.

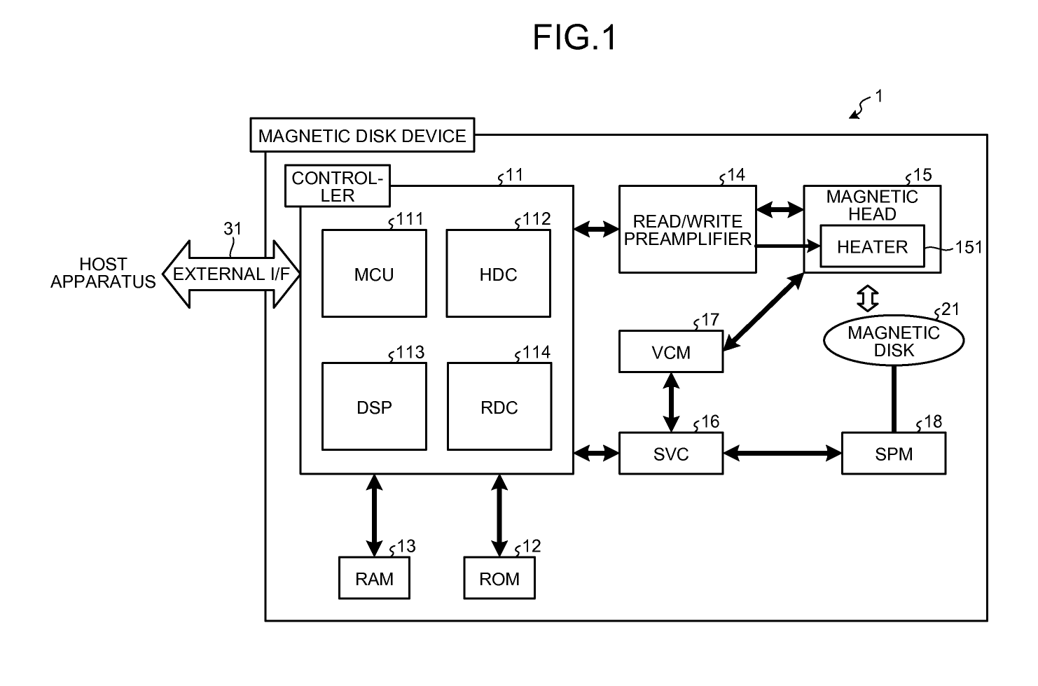

FIG. 1 is a block diagram of a magnetic storage device according to an embodiment. The magnetic storage device of the embodiment will be described as a magnetic disk device.

A magnetic disk device 1 comprises a controller 11, a read only memory (ROM) 12, a random access memory (RAM) 13, a read/write preamplifier 14, a magnetic head 15, a servo controller (SVC) 16, a voice coil motor (VCM) 17, a spindle motor (SPM) 18, and a magnetic disk 21. The magnetic head 15 comprises a heater 151. For the sake of simplicity, although the magnetic head 15 and the magnetic disk 21 will be described as being provided one each, there may be two or more of them.

The controller 11 is connectable to an external host apparatus via an external interface (I/F) 31. The controller 11 comprises a micro controller unit (MCU) 111, a hard disk controller (HDC) 112, a digital signal processor (DSP) 113, and a read channel (RDC) 114. The MCU 111 controls the magnetic disk device 1 in entirety. The HDC 112 controls the constituent elements of the magnetic disk device 1. The DSP 113 performs a variety of signal processing operations such as an operation of converting (encoding) write data that is input from the host apparatus into a suitable format for recording in the magnetic disk 21 or an operation of converting (encoding) read data that is reproduced from the magnetic disk 21 into a suitable format for transferring to the host apparatus. The RDC 114 controls the transfer of write data to the magnetic head 15 or the transfer of read data from the magnetic head 15.

The ROM 12 is used to store programs that are executed in the controller 11 or to store data. The RAM 13 is used to store a variety of data such as data required for operations performed in the controller 11 or intermediate data during operations. Besides, the RAM 13 provides a work area for the controller 11. The ROM 12 and the RAM 13 constitute a storage module and can also be configured from a storage device other than a semiconductor storage device.

The read/write preamplifier 14 performs operations such as amplification on the write data received from the controller 11 (i.e., from the DSP 113 and the RDC 114) and sends the amplified data to the magnetic head 15. Besides, the read/write preamplifier 14 performs operations such as amplification on the read data reproduced from the magnetic disk 21 and sends the amplified data to the controller 11 (i.e., to the DSP 113 and the RDC 114). Meanwhile, via the read/write preamplifier 14, the controller 11 controls the heater 151 disposed inside the magnetic head 15. The control of the heater 151 includes controlling the ON/OFF status of the heater 151 and controlling the amount of heat generated from the heater 151. The amount of heat generated from the heater 151 is controlled by controlling the current applied thereto. The ON/OFF status of the heater 151 and the amount of heat generated from the heater 151 can be controlled by implementing known methods. The SVC 16 controls the VCM 17, which moves the magnetic head 15 in the radial direction of the magnetic disk 21 under the control of the controller 11. In addition, the SVC 16 also controls the SPM 18, which rotates the magnetic disk 21 under the control of the controller 11.

In the embodiment, at least a portion of the controller 11 constitutes a head flying height control circuit. That is, the head flying height control circuit can be configured from at least the HDC 112 and can also comprise the MCU 111 and/or the read/write preamplifier 14.

Meanwhile, the basic configuration of the magnetic disk device 1 is not limited to that illustrated in FIG. 1 and a variety of known basic configurations can also be adopted as long as it comprises a magnetic head with a heater, a controller for controlling the amount of heat generated from the heater, and a storage module for storing a variety of data.

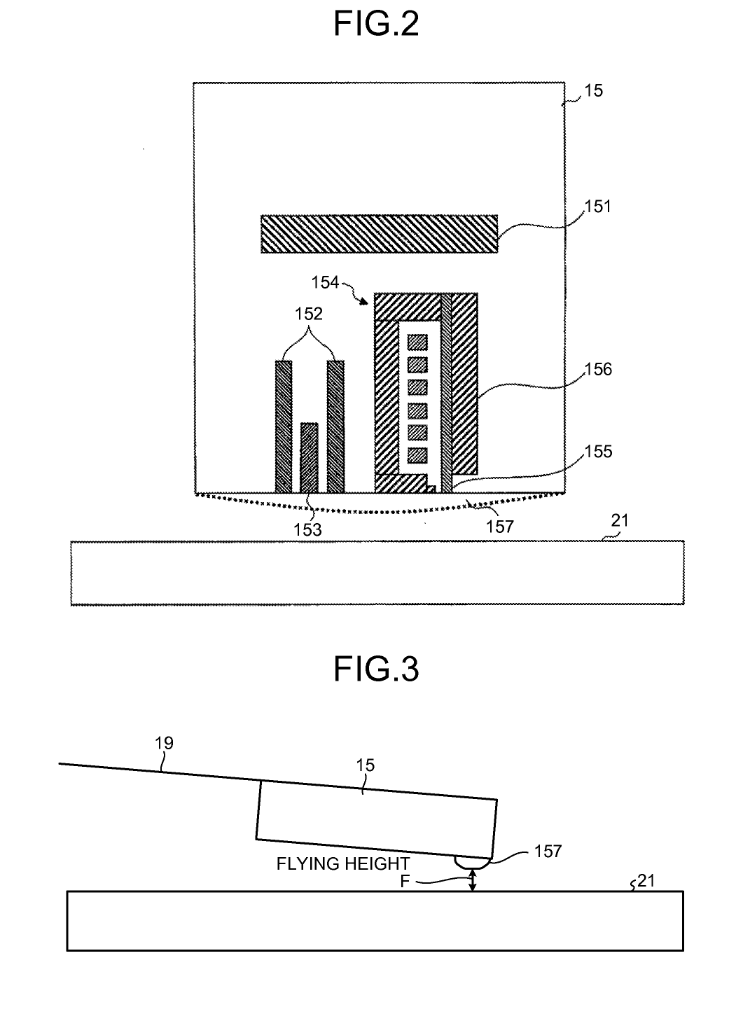

FIG. 2 is a partial cross-sectional view of the magnetic head 15. The magnetic head 15 comprises the heater 151, a shield 152, a read head 153, and a write head 154, which in turn comprises a main magnetic pole 155 and a return yoke 156. Upon being applied with a current, the heater 151 generates heat so that a protruding portion 157 of the magnetic head 15 protrudes, as illustrated by a dashed line, towards the recording surface of the magnetic disk 21 due to thermal expansion. The protruding portion 157 comprises the element portion of the read head 153 and the write head 154 that constitute the magnetic head 15.

FIG. 3 is an explanatory diagram for explaining the flying height of the magnetic head 15 from the magnetic disk 21. The magnetic head 15 is fixed to a suspension 19 that is disposed on the leading end of an arm (not illustrated) having a known configuration. When the heater 151 generates heat, there occurs a change in the distance between the magnetic head 15 and the magnetic disk 21, i.e., the distance between the protruding portion 157 and the recording surface of the magnetic disk 21. In the following explanation, that distance is referred to as a flying height F of the magnetic head 15 with respect to the magnetic disk 21. Greater the amount of heat generated from the heater 151, smaller is the flying height F; and smaller the amount of heat generated from the heater 151, greater is the flying height F.

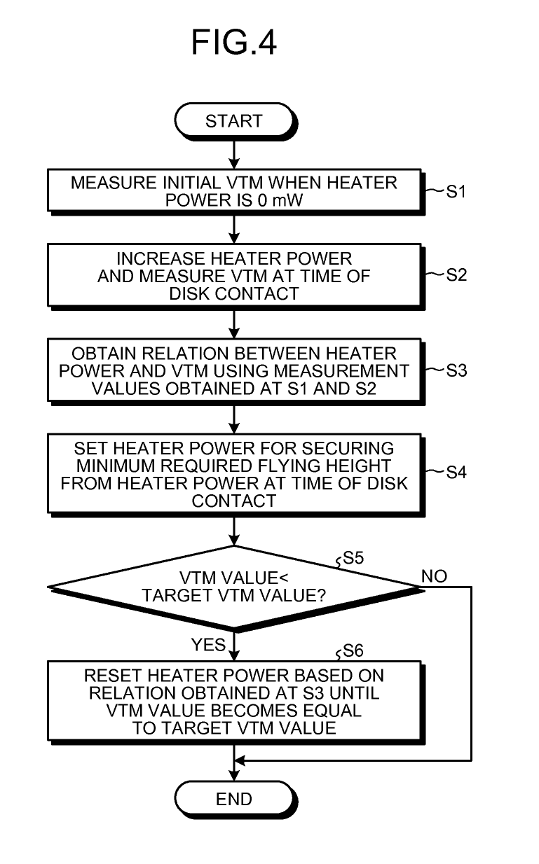

FIG. 4 is a flowchart of the operation of the controller 11 for controlling the head flying height. The operation illustrated in FIG. 4 is performed particularly by the HDC 112 under the control of the MCU 111, and is initiated at the time of shipping the magnetic disk device 1 from the factory. However, alternatively, the operation illustrated in FIG. 4 can also be initiated after the magnetic disk device 1 is shipped from the factory. Regarding the case of initiating the operation illustrated in FIG. 4 after the magnetic disk device 1 is shipped from the factory, initiation of the operation can be done at any of the following exemplary timings: when the error rate of the data reproduced from the magnetic disk 21 exceeds a predetermined value; when the signal level of the read data reproduced from the magnetic disk 21 decreases by a predetermined ratio (%) or more with respect to a reference signal level thereby causing deterioration in the signal characteristic; for each time the magnetic disk device 1 switched ON; at regular intervals of a predetermined time period; and upon receiving an input of an initiation instruction from the user at an arbitrary point of time. Herein, in order to explain the variability in the recording/reproducing characteristic of different magnetic heads, the following explanation is given for a case in which calibration is performed for magnetic heads A, B, and C each functioning as the magnetic head 15. Meanwhile, the magnetic heads A, B, and C can be installed in separate magnetic disk devices 1 or in the same magnetic disk device 1.

With reference to FIG. 4, at the time when the amount of heat generated from the heater 151 (hereinafter, simply referred to as “heater power”) due to the application of a heater current to the heater 151 is 0 mW, an initial value of a head/medium property is measured and stored in the storage module (in the RAM 13) (S1). Herein, the head/medium property is any one of the Viterbi Trellis margin (VTM), the error rate, the head output, or the signal-to-noise ratio (SNR). At the time of signal demodulation, in order to clearly distinguish the difference between a correct path and an error path, the difference with an ideal value (metric value) is required to be large. In regard to that point, VTM is defined as the number when the difference in the metric value due to a correct path and an error path falls below a certain threshold value, and a greater value of the VTM indicates an error-prone condition. The error rate is defined as, for example, the rate of occurrence of an error in read data when predetermined data is reproduced after it has been recorded for a predetermined number of times in the magnetic disk 21. The error rate is used as an index that indicates the performance of the magnetic disk 21. In the embodiment, for the sake of simplicity in the explanation, the error rate is assumed to be, for example, a sector error rate (number of error sectors/total number of read sectors) that is defined as the number of sectors having an error with respect to the total number of reproduced sectors. The head output indicates read data reproduced from the magnetic disk 21 by the magnetic head 15.

In the embodiment, for the sake of simplicity in the explanation, VTM is used as the head/medium property. Accordingly, at the time when the heater power is 0 mW, an initial value of the VTM is measured and stored in the storage module (in the RAM 13) (S1). Then, the heater current applied to the heater 151 is increased in such a way that, at each uniform step, the heater power increases until the protruding portion 157 of the magnetic head 15 protrudes by the maximum protrusion amount, and a VTM value at each step is measured and stored in the storage module (S2). Herein, the uniform steps are assumed to be equal to 10 mA. Alternatively, as long as it is possible to obtain the correlation between the heater power (or the heater current) and the VTM value, the uniform steps can vary within a certain range. Meanwhile, in the embodiment, the maximum protrusion amount is assumed to be the protrusion amount of the protruding portion 157 of the magnetic head 15 at the time when the protruding portion 157 makes contact with the recording surface of the magnetic disk 21. Subsequently, the relation between the heater power and the VTM value obtained at S1 and S2 is obtained and stored in the storage module (S3).

As the heater power is kept increasing, the magnetic head 15 (the protruding portion 157) makes contact with the magnetic disk 21 at some point of time. That contact can be detected by implementing any of the various known methods. For example, a signal reproduced from the magnetic disk 21 by the magnetic head 15 can be directly monitored inside the controller 11 and a contact can be determined to have occurred if the monitored signal does not grow in amplitude, if the monitored signal decreases in amplitude, if the monitored signal is not correctly readable due to noise generation, if saturation occurs regarding variation in the amplitude of the monitored signal, or if a predetermined vibration of the magnetic head 15 is detected.

Subsequently, either the VIM value measured at the time of detection of a contact between the magnetic head 15 and the magnetic disk 21 or the VTM value measured just prior to the time of detection of a contact is stored as VM1 in the storage module (S4). In the embodiment, regarding each of the magnetic heads A to C, it is assumed that the heater current of 90 mA leads to the detection of a contact between the magnetic head 15 and the magnetic disk 21 and it is assumed that the VTM value measured corresponding to the heater current of 80 mA is stored in the storage module as the VTM value measured correctly just prior to the time of detection of a contact.

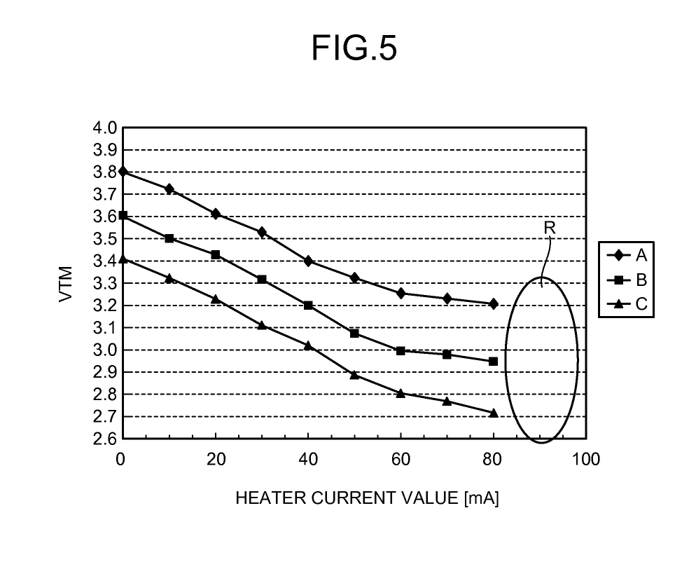

FIG. 5 is a graph of the relation between the VIM values and the heater current stored in the storage module at S4. The vertical axis in FIG. 5 represents the VIM values and the horizontal axis therein represents the heater current (mA). In FIG. 5, diamond-shaped markings indicate the measured data for the magnetic head A, black quadrangular markings indicate the measured data for the magnetic head B, and triangular markings indicate the measured data for the magnetic head C. Moreover, in FIG. 5, “R” indicates the region in which data cannot be correctly measured due to a contact between the magnetic head 15 and the magnetic disk 21.

Consider an exemplary case when it is known in advance that each of the magnetic heads A to C protrudes with respect to the heater power by a protrusion amount of 0.125 nm/mW and the minimum required flying height F is desirably between in the range of about 4 nm to about 6 nm by taking into consideration the thickness of a diamond-like carbon (DLC) protective film, glide height, and a lubricant agent formed on the surface of the magnetic disk 21, i.e., by estimating from a safety margin against HDI. If the minimum required flying height F is assumed to be 5 nm; then the magnetic head 15 can be floated by 5 nm from the recording surface of the magnetic disk 21 by applying to the heater 151 a heater current for generating the heater power of 40 mW (=80 mW−40 mW). Herein, regarding each of the magnetic heads A to C, it is assumed that the heater current of 90 mA leads to the detection of a contact between the magnetic head 15 and the magnetic disk 21. However, sometimes, when the heater current is zero, variability occurs in the absolute flying height of the magnetic head 15. If variability exists in the absolute flying height, then there occurs a change in the heater current at the time of a contact between the magnetic head 15 and the magnetic disk 21. In such a case, the heater current is correctible.

In the embodiment, when the magnetic head 15 is floated from the magnetic disk 21 by only the minimum required flying height F of 5 nm, it means that there is almost no safety margin against HDI. In such a condition, even only a small amount of dust may trigger a head crash. Hence, for the magnetic disk 21 having some latitude in the recording/reproducing characteristic, increasing the flying height F acts favorably from the perspective of HDI safety margin.

Meanwhile, in the embodiment, for achieving a satisfactory performance of the magnetic disk device 1, the VTM value is assumed to be 3.3. Hence, even if the minimum required flying height F is set to 5 nm; the flying height F for the magnetic head 15 having some latitude in the recording/reproducing characteristic can be increased until the VTM value is 3.3. That makes it possible to secure a safety margin against VTM as well as HDI.

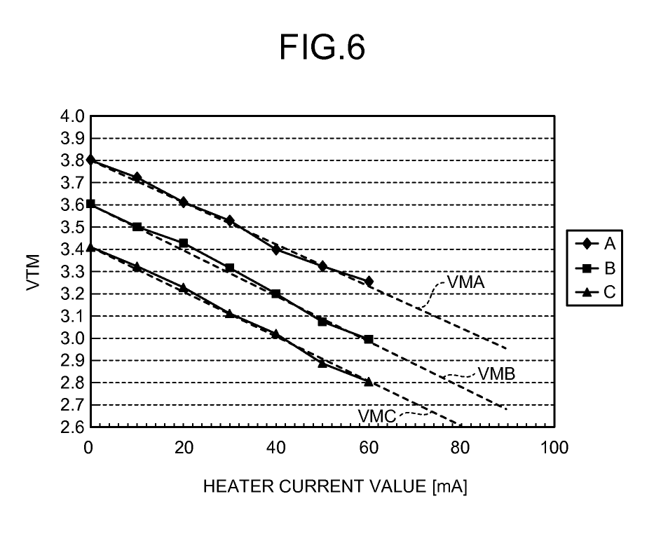

Returning to the description with reference to FIG. 4, subsequently it is determined whether the VTM value is smaller than a target VTM value of 3.3 (S5). If the VTM value is smaller than the target VTM value (Yes at S5), then the system control proceeds to S6; while if the VTM value is not smaller than the target VTM value (No at S5), then the processing is completed. If there is some latitude in the VTM value and if the VTM value is smaller than the target VTM value (Yes at S5); then, based on the relation between the heater current and VTM value as illustrated in FIG. 5 and obtained at S3, the heater current (or the heater power) is reset until the VTM value becomes equal to the target VTM value of 3.3 (S6) and then the processing is completed. In the embodiment, using approximation formulae in the range of 0 mA to 60 mA that is the actual range of use, following relations can be obtained regarding the magnetic heads A to C. In the following relations, x represents a heater current value. FIG. 6 is a graph representing the heater current reset using the approximation formulae. The vertical axis in FIG. 6 represents the VTM values and the horizontal axis therein represents the heater current (mA). In FIG. 6, diamond-shaped markings indicate the measured data for the magnetic head A; black quadrangular markings indicate the measured data for the magnetic head B; triangular markings indicate the measured data for the magnetic head C; and VMA, VMC, and VMC respectively represent the reset VTM values of the magnetic heads A to C.

VMA=−0.0094x+3.81

VMB=−0.0102x+3.61

VMC=−0.0101x+3.42

Thus, the heater current values for achieving the target VTM value of 3.3 can be instantly calculated using the abovementioned approximation formulae. Hence, it becomes possible to instantly reset the heater current without having to perform heater current setting while newly measuring the VTM values. Meanwhile, for VTM=3.3, calculation of the heater current values with respect to the magnetic heads A to C yields following result:

magnetic head A: x=54.3 mA

magnetic head B: x=30.4 mA

magnetic head C: x=11.9 mA

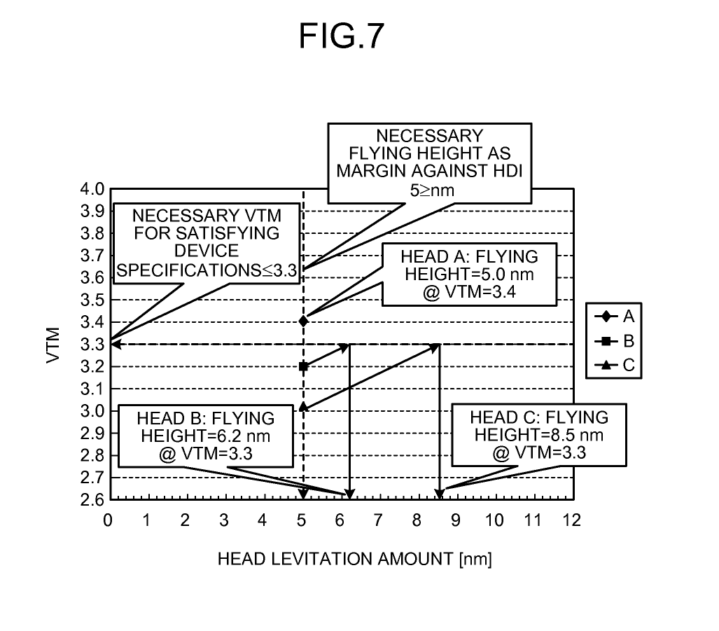

By resetting the heater current with respect to the magnetic heads A to C in the abovementioned manner, the VTM values can be set to 3.3. Regarding the magnetic head A, at the point of time when the flying height F is set to 5 nm, the VTM value is already 3.43, thus exceeding the target VTM value of 3.3. In that case, the priority is placed on HDI safety margin and the heater current is not varied. In contrast, regarding the magnetic heads B and C, the possible extent of increase in the flying height F is illustrated in FIG. 7, which is a graph representing the relation between the flying height F and the VTM values after the heater current values for the magnetic heads A to C have been reset. The vertical axis in FIG. 7 represents the VTM values and the horizontal axis therein represents the flying height F of the magnetic head 15. In FIG. 7, diamond-shaped markings indicate the measured data for the magnetic head A, black quadrangular markings indicate the measured data for the magnetic head B, and triangular markings indicate the measured data for the magnetic head C. As seen in FIG. 7, it was confirmed that, resetting the heater current (or the heater power) to a lower level enables securing a safety HDI margin of 1.2 nm (=6.2 nm-5.0 nm) for the magnetic head B and enables securing a safety HDI margin of 3.5 nm (=8.5 nm−5.0 nm) for the magnetic head C.

In order to perform the operation illustrated in FIG. 4, the head flying height control circuit comprises a first module that increases the heater power of the heater 151 and causes protrusion of the protruding portion 157 to the maximum protrusion amount; a second module that reduces the heater power based on a relation between the protrusion amount and the heater power until the protrusion amount is set to a predetermined amount; and a third module that, if a head/medium property is better than a target value upon reduction in the heater power by the second module, reduces the heater power based on a relation between the head/medium property and the heater power so that the head/medium property matches the target value.

In addition, the head flying height control circuit also comprises a detecting module that detects a contact between the magnetic head 15 and the magnetic disk 21 upon an increase in the heater power and a head/medium property obtaining module that obtains the head/medium property based on the read data reproduced from the magnetic disk 21 by the magnetic head 15. Meanwhile, herein, the maximum protrusion amount can be considered to be the protrusion amount at the time when the magnetic head 15 makes contact with the magnetic disk 21.

Besides, the head flying height control circuit can also comprise a module that, based on a head/medium property at the time when the heater power is zero and the head/medium property at the time of the maximum protrusion amount, calculates the relation between a head/medium property and the heater power.

In the description given above, the VTM is used as the head/medium property. Instead, even if the error rate, the head output, or the SNR is used as the head/medium property; heater current resetting can still be performed in an identical manner to that described above.

Thus, in the head flying height control for controlling the flying height of a magnetic head, which comprises an element portion and a heater that effects a change in the protrusion amount of the element portion due to thermal expansion accompanying heat generation, from a magnetic storage medium, the element portion is made to protrude to a maximum protrusion amount by increasing the heater power of the heater; the heater power is reduced based on a relation between the protrusion amount and the heater power until the protrusion amount is set to a predetermined amount; and, if a head/medium property is better than a target value, then, based on the relation between the head/medium property and the heater power, the heater power is so reduced that the head/medium property matches the target value. If the head/medium property is either one of the VTM and the error rate and if the head/medium property is smaller than a target value, then, based on the relation between the head/medium property and the heater power, the heater power is so reduced that the head/medium property matches the target value. On the other hand, if the head/medium property is either one of the head output and the SNR and if the head/medium property is greater than a target value, then, based on the relation between the head/medium property and the heater power, the heater power is so reduced that the head/medium property matches the target value.

Meanwhile, the head/medium property can be measured at an arbitrary location on the magnetic disk 21 and under an arbitrary temperature environment. However, alternatively, the head/medium property can also be measured at a plurality of locations on the magnetic disk 21 and/or under a plurality of temperature environments. By measuring the head/medium property at a plurality of locations on the magnetic disk 21, the measurement data obtained thereat can be substituted for the data at the non-measured locations. That enables achieving enhancement in the setting accuracy of the heater current (or the heater power) across the entire area of the recording surface. In this case, the locations on the magnetic disk 21 include, for example, an inner periphery zone, a central periphery zone, and an outer periphery zone on the magnetic disk 21. Similarly, by measuring the head/medium property under a plurality of temperature environments, the measurement data obtained thereat can be substituted for the data regarding the non-measured temperature environments. That enables achieving enhancement in the setting accuracy of the heater current (or the heater power) across all temperature environments. In this case, the temperature environments include, for example, a low-temperature environment, a room-temperature environment, and a high-temperature environment.

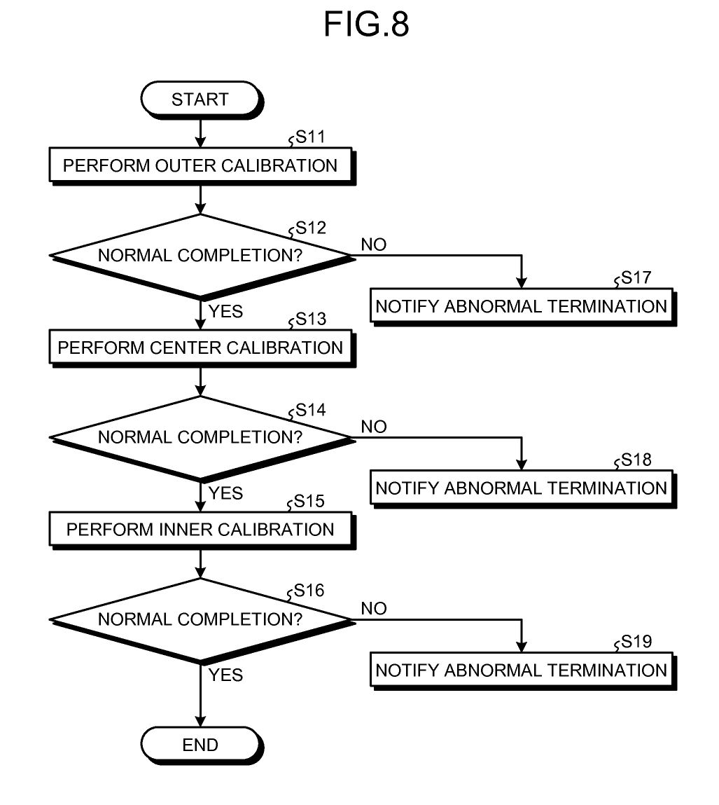

FIG. 8 is a flowchart of the operation for measuring the head/medium property at a plurality of locations on the magnetic disk 21. With reference to FIG. 8, if the VTM is used the head/medium property, then the operation described with reference to FIG. 4 (hereinafter, referred to as “calibration”) is performed at the outer periphery zone (or simply “outer zone”) on the magnetic disk 21 (S11). Subsequently, it is determined whether the calibration has successfully ended (S12). If the calibration has not successfully ended (No at S12), then a notification of abnormal termination is sent to the host apparatus (S17). On the other hand, if the calibration has successfully ended (Yes at S12); then the calibration is performed at the central periphery zone (or simply “central zone”) on the magnetic disk 21 (S13). Subsequently, it is determined whether the calibration has successfully ended (S14). If the calibration has not successfully ended (No at S14), then a notification of abnormal termination is sent to the host apparatus (S18). On the other hand, if the calibration has successfully ended (Yes at S14); then the calibration is performed at the inner periphery zone (or simply “inner zone”) on the magnetic disk 21 (S15). Subsequently, it is determined whether the calibration has successfully ended (S16). If the calibration has not successfully ended (No at S16), then a notification of abnormal termination is sent to the host apparatus (S19). On the other hand, if the calibration has successfully ended (Yes at S16); then the processing is completed.

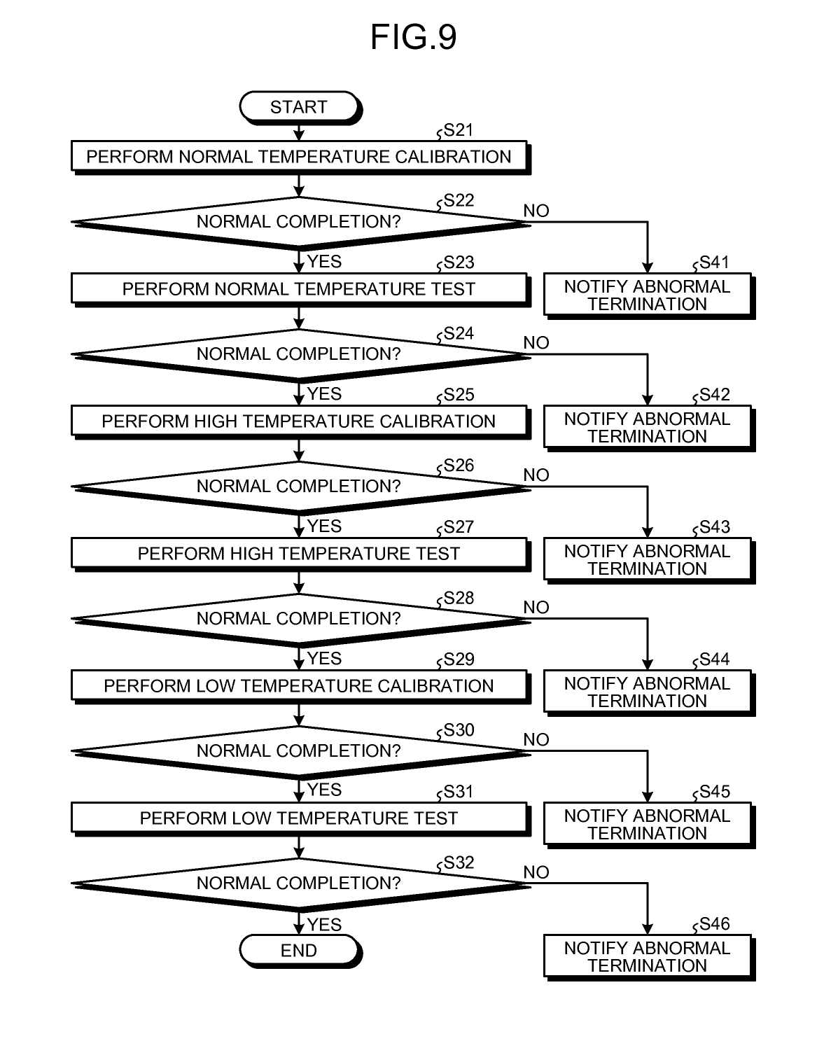

FIG. 9 is a flowchart of the operation for measuring the head/medium property under a plurality of temperature environments. With reference to FIG. 9, if the VTM is used the head/medium property, then the operation described with reference to FIG. 4 (hereinafter, referred to as “calibration”) is performed at the normal temperature (S21). Herein, the normal temperature is assumed to be, for example, a room temperature of 25° C. Subsequently, it is determined whether the normal temperature calibration has successfully ended (S22). If the normal temperature calibration has not successfully ended (No at S22), then a notification of abnormal termination is sent to the host apparatus (S41). On the other hand, if the normal temperature calibration has successfully ended (Yes at S22); then a known normal temperature test is performed on the magnetic disk 21 (S23). Then, it is determined whether the normal temperature test has successfully ended (S24). If the normal temperature test has not successfully ended (No at S24); then a notification of abnormal termination is sent to the host apparatus (S42). On the other hand, if the normal temperature test has successfully ended (Yes at S24); then the calibration is performed at a high temperature (S25). Herein, the high temperature is assumed to be, for example, 60° C. Subsequently, it is determined whether the high temperature calibration has successfully ended (S26). If the high temperature calibration has not successfully ended (No at S26), then a notification of abnormal termination is sent to the host apparatus (S43). On the other hand, if the high temperature calibration has successfully ended (Yes at S26); then a known high temperature test is performed on the magnetic disk 21 (S27). Then, it is determined whether the high temperature test has successfully ended (S28). If the high temperature test has not successfully ended (No at S28); then a notification of abnormal termination is sent to the host apparatus (S44). On the other hand, if the high temperature test has successfully ended (Yes at S28); then the calibration is performed at a low temperature (S29). Herein, the low temperature is assumed to be, for example, 5° C. Subsequently, it is determined whether the low temperature calibration has successfully ended (S30). If the low temperature calibration has not successfully ended (No at S30), then a notification of abnormal termination is sent to the host apparatus (S45). On the other hand, if the low temperature calibration has successfully ended (Yes at S30); then a known low temperature test is performed on the magnetic disk 21 (S31). Then, it is determined whether the low temperature test has successfully ended (S32). If the low temperature test has not successfully ended (No at S32); then a notification of abnormal termination is sent to the host apparatus (S46). On the other hand, if the low temperature test has successfully ended (Yes at S32); then the processing is completed.

Meanwhile, the tests performed at S23, S27, and S31 include, for example, a test in which random data is recorded in a random address on the magnetic disk 21 and it is determined whether the data is reproducible without error or a test in which specific test data is sequentially recorded in a series of addresses starting with the address 0 and it is determined whether the data is reproducible without error. By performing such tests, even if the data is not reproduced normally but if a retry thereof leads to error resolution, then it is considered to be normal completion. Moreover, if setting of an alternate area leads to error resolution, then it is considered to normal completion. However, by performing such tests, if neither retries nor setting of an alternate area leads to error resolution; then it is considered to be abnormal termination.

In the abovementioned manner, the heater current (or the heater power) is reset in advance at the time of assembling the magnetic disk device 1 in the factory, i.e., prior to shipping the magnetic disk device 1. Hence, upon shipment of the magnetic disk device 1, the user is able to use the already reset heater current (or the heater power) and thus prevent an increase in the measurement time accompanying resetting as well as prevent an increase in the number of contacts between the magnetic head 15 and the magnetic disk 21. For that reason, the reliability of the magnetic disk device 1 can be prevented from being eroded. Moreover, upon shipment of the magnetic disk device 1, even if there is detection of an error in the data reproduced from the magnetic disk 21 or detection of deterioration in the signal characteristic at the user side, resetting of the heater current (or the heater power) in the abovementioned manner can prevent the magnetic disk device 1 from malfunctioning.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head flying height control method for controlling a flying height of a magnetic head from a magnetic storage medium, the magnetic head comprising an element portion and a heater configured to change an amount of protrusion of the element portion due to thermal expansion with heat, the head flying height control method comprising:
causing the element portion to protrude by increasing the heat by the heater;
reducing the heat until the amount of protrusion becomes substantially equal to a predetermined protrusion amount; and
matching a head-medium characteristic to a target value by heat reduction, if the head-medium characteristic is not substantially equal to the target value after the reducing.

2. The head flying height control method of claim 1, wherein
the head-medium characteristic is either a Viterbi Trellis margin or an error rate, and
the matching comprises matching the head-medium characteristic to the target value by heat reduction, if the head-medium characteristic is smaller than the target value after the reducing.

3. The head flying height control method of claim 1, wherein
the head-medium characteristic is either a head output or a signal-to-noise ratio, and
the matching comprises matching the head-medium characteristic to the target value by heat reduction, if the head-medium characteristic is greater than the target value after the reducing.

4. The head flying height control method of claim 1, wherein the substantially large protrusion amount is an amount of protrusion that causes the magnetic head to be in contact with the magnetic storage medium.

5. The head flying height control method of claim 1, further comprising calculating a relation between the head-medium characteristic and the heat, based on a head-medium characteristic when the heat is substantially zero and the head-medium characteristic when the amount of protrusion is substantially large.

6. The head flying height control method of claim 1, wherein
the causing, the reducing, and the matching are executed under a low-temperature environment, a room-temperature environment, and a high-temperature environment, respectively,
a heat at a temperature is calculated based on data measured under the low-temperature environment, the room-temperature environment, and the high-temperature environment, and
a head-medium distance is controlled according to an environment temperature.

7. The head flying height control method of claim 1, wherein
the causing, the reducing, and the matching are executed in an inner periphery zone, a central periphery zone, and an outer periphery zone of the magnetic storage medium, respectively,
a heat at a location on the magnetic storage medium is calculated based on data measured in the inner periphery zone, the central periphery zone, and the outer periphery zone, and
a head-medium distance is controlled according to the location on the magnetic storage device.

8. The head flying height control method of claim 1, wherein the predetermined protrusion amount corresponds to a substantially small flying height of the magnetic head from the magnetic storage medium estimated from a margin against head disk interference.

9. The head flying height control method of claim 1, wherein the causing, the reducing, and the matching are executed upon detection of deterioration in a signal characteristic or detection of an error in data read by the magnetic head from the magnetic storage medium and reproduced.

10. Ahead flying height controller for controlling a flying height of a magnetic head from a magnetic storage medium, the magnetic head comprising an element portion and a heater configured to change an amount of protrusion of the element portion due to thermal expansion with heat, the head flying height controller comprising:
a first module configured to cause the element portion to protrude by increasing a heat of the heater;
a second module configured to reduce the heat until the amount of protrusion becomes substantially equal to a predetermined protrusion amount; and
a third module configured to match a head-medium characteristic to a target value by heat reduction, if the head-medium characteristic is not substantially equal to the target value after the second module reduced the heat.

11. The head flying height controller of claim 10, further comprising:
a detecting module configured to detect a contact between the magnetic head and the magnetic storage medium upon an increase in the heat; and
a head-medium characteristic calculation module configured to calculate the head-medium characteristic based on data read by the magnetic head from the magnetic storage medium and reproduced, wherein
the substantially large protrusion amount is an amount of protrusion that causes the magnetic head to be in contact with the magnetic storage medium.

12. The head flying height controller of claim 10, wherein
the head-medium characteristic is either a Viterbi Trellis margin or an error rate, and
the third module is configured to match the head-medium characteristic to the target value by heat reduction, if the head-medium characteristic is smaller than the target value after the second module reduced the heat.

13. The head flying height controller of claim 10, wherein
the head-medium characteristic is either a head output or a signal-to-noise ratio, and
the third module is configured to match the head-medium characteristic to the target value by heat reduction, if the head-medium characteristic is greater than the target value after the second module reduced the heat.

14. The head flying height controller of claim 10, further comprising a calculator configured to calculate a relation between the head-medium characteristic and the heat, based on a head-medium characteristic when the heat is substantially zero and the head-medium characteristic when the amount of protrusion is substantially large.

15. The head flying height controller of claim 10, wherein
the first module, the second module, and the third module are configured to execute under a low-temperature environment, a room-temperature environment, and a high-temperature environment, respectively,
a heat at a temperature is calculated based on data measured under the low-temperature environment, the room-temperature environment, and the high-temperature environment, and
a head-medium distance is controlled according to an environment temperature.

16. The head flying height controller of claim 10, wherein
the first module, the second module, and the third module are configured to execute in an inner periphery zone, a central periphery zone, and an outer periphery zone of the magnetic storage medium, respectively,
a heat at a location on the magnetic storage medium is calculated based on data measured in the inner periphery zone, the central periphery zone, and the outer periphery zone, and
a head-medium distance is controlled according to the location on the magnetic storage device.

17. The head flying height controller of claim 10, wherein the predetermined protrusion amount corresponds to a substantially small flying height of the magnetic head from the magnetic storage medium estimated from a margin against head disk interference.

18. The head flying height controller of claim 10, wherein the first module, the second module, and the third module are configured to execute upon detection of deterioration in a signal characteristic or detection of an error in data read by the magnetic head from the magnetic storage medium and reproduced.

19. A magnetic storage device, comprising:
a magnetic head comprising an element portion and a heater configured to change an amount of protrusion of the element portion due to thermal expansion with heat; and
a head flying height controller configured to control a flying height of the magnetic head from a magnetic storage medium, the head flying height controller comprising:
a first module configured to cause the element portion to protrude by increasing a heat of the heater;
a second module configured to reduce the heat until the amount of protrusion becomes substantially equal to a predetermined protrusion amount; and
a third module configured to match a head-medium characteristic to a target value by heat reduction, if the head-medium characteristic is not substantially equal to the target value after the second module reduced the heat.

20. The magnetic storage device of claim 19, further comprising a storage module configured to store the relation between the amount of protrusion and the heat and the relation between the head-medium characteristic and the heat.
